(19) United States
(12) Patent Application Publication
(10) Pub. No.: US 2009/0104477 A1
(43) Pub. Date: Apr. 23, 2009

(54) FUEL CELL AND INFORMATION DEVICE

(76) Inventors: Dong-Rak Kim, Suwon-si (KR); In-Seob Song, Suwon-si (KR); Jung-Kurn Park, Suwon-si (KR); Sang-Cheol Lee, Suwon-si (KR); Jun-Won Suh, Suwon-si (KR)

Correspondence Address: CHRISTIE, PARKER & HALE, LLP, PO BOX 7068, PASADENA, CA, 91109-7068, US

(21) Appl. No.: 12/177,760

(22) Filed: Jul. 22, 2008

(30) Foreign Application Priority Data
Oct. 23, 2007 (KR) 10-2007-0106767

(51) Int. Cl. H01M 8/00; H01M 8/04

(52) U.S. Cl. 429/13; 429/23

(57) ABSTRACT

The present invention relates to a fuel cell capable of transferring a power generation state and coupling information of the fuel cell to an external apparatus and relates to an information device capable of receiving power and information from the fuel cell. The fuel cell includes a fuel cell stack for generating electricity by an electrochemical reaction of a fuel and an oxidant; a fuel supplier for supplying the fuel to the fuel cell stack; a set of output terminals for outputting electricity generated from the fuel cell stack and for outputting information on a power generation state of the fuel cell; and a power supply information processing unit for applying a voltage level according to the information to any one of the set of output terminals.

### CROSS-REFERENCE TO RELATED APPLICATIONS

This application claims priority to and the benefit of Korean Patent Application No. 10-2007-0106767, filed on Oct. 23, 2007 in the Korean Intellectual Property Office, the entire content of which is incorporated herein by reference.

### BACKGROUND

1. Field of the Invention

The present invention relates to a fuel cell capable of transferring the power generation state and coupling information of the fuel cell to an external apparatus and an information device capable of receiving power and information from the fuel cell.

2. Discussion of Related Art

A portable information device represented by a notebook, which is an information device that is easily carried and accommodates people with information processing convenience, has been expanded in view of the number of users and the range of use. The importance of assuring a stable power supplying means for the portable information device has become very high in consideration of providing convenience to users.

As a power supply for the portable information device, a primary cell has been used, but a rechargeable secondary cell is being used recently. However, because portable information devices such as notebooks, digital multimedia broadcasting (DMB) receivers, or wireless portable internet terminals require long operation time and consume a lot of power, the capacity of the secondary cell supplying power to portable information devices is insufficient. Also, the time to recharge the discharged secondary cell is considerable.

For these reasons, using a separate power generation device is suitable to supply power to portable information devices that consume a lot of power. Among the available power generation devices, fuel cells suitable for compactness have been studied as the power generation device for portable information devices. Therefore, a structure and a method for supplying power to portable information devices using the fuel cell have recently been suggested in various forms.

Generally, a fuel cell is a power generation system for directly converting chemical energy into electric energy by means of an electrochemical reaction of hydrogen and oxygen. Pure hydrogen gas may be directly supplied to the fuel cell, or hydrogen gas obtained by reforming materials such as methanol, ethanol, and natural gas may be supplied thereto. Pure oxygen may be directly supplied to the fuel cell, or oxygen contained in air may be supplied thereto.

Fuel cell types include a polymer electrolyte membrane fuel cell and a direct methanol fuel cell operating at normal temperature or 100° C. or less, a phosphoric acid fuel cell operating at about 150° C. to 200° C., a molten carbonate fuel cell operating at about 600° C. to 700° C., and a solid oxide fuel cell operating at about 1000° C. or more. These respective fuel cells are basically the same in view of a principle of generating electricity, but have different fuels, catalysts, electrolytes, etc.

Among others, the direct methanol fuel cell (DMFC) directly uses liquid fuel that is a mixture of methanol and water instead of using hydrogen gas as fuel. The DMFC is lower in output density than a fuel cell using hydrogen gas as fuel. However, the DMFC has advantages in that it has a high energy density per volume of methanol used as fuel, easily stores the fuel, and allows the operation at a low output and for a long time. Also, the DMFC can be more compactly constituted because an additional device, such as a reformer for reforming fuel to generate hydrogen is not needed.

The DMFC includes a membrane electrode assembly (MEA) configured of a polymer electrolyte membrane, and an anode electrode and a cathode electrode arranged on opposite sides of the polymer electrolyte membrane. For a polymer electrode membrane, a fluoride polymer may be used. However, since the methanol is excessively and rapidly permeated into a fluoride polymer membrane, a crossover phenomenon by which methanol is transferred across the polymer electrolyte membrane when the direct methanol fuel cell uses a high concentration of methanol as fuel. Accordingly, in order to lower the concentration of methanol, a mixed fuel of methanol and water must be supplied to the fuel cell.

The polymer electrolyte membrane fuel cell (PEMFC) may use hydrogen generated by reforming materials such as methanol, ethanol, and natural gas. The PEMFC has advantages of high output characteristics, low operating temperature, and rapid starting and response characteristics, as compared to other fuel cells. Therefore, the PEMFC is widely applicable to a mobile power supply for an automobile as well as a distributed power supply for a house or a public building, and is applicable as a power supply for a small mobile device such as a portable electronic device.

The PEMFC includes a reformer for converting raw materials into a reforming gas rich in hydrogen by a catalytic reaction such as steam reforming (SR), water gas shift (WGS), etc. The reformer also removes carbon monoxide that is contained in the reforming gas to prevent poisoning of the catalyst of the fuel cell.

As a general method of supplying power to the portable information device using the fuel cell, there are forms as shown in FIG. 1A, FIG. 1B, and FIG. 1C. The power supply form of FIG. 1A illustrates that a portable information device 1 is supplied with power only from a fuel cell 2. The power supply form of FIG. 1B illustrates that a fuel cell 2 supplies its power only to a battery 3. The power supply form of FIG. 1C illustrates that an information device is supplied with power from the battery 3 which is charged by means of the fuel cell 2.

### SUMMARY OF THE INVENTION

Generally, a battery powered portable information device monitors the remaining amount of energy in the battery and operates a power supply management program informing a user of the remaining amount of energy in the battery at a particular time point. With respect to receiving power from the fuel cell, it is necessary to provide a process of monitoring the remaining amount of energy in a fuel cell. That is, there is a need for solutions of monitoring the remaining amount of fuel in a fuel cell and informing a user thereof to provide convenience to a user.

Exemplary embodiments of the present invention provide a fuel cell capable of transferring the power generation state and coupling information of the fuel cell to an external apparatus and to an information device capable of receiving power and the information from the fuel cell.

Exemplary embodiments of the present invention also provide a fuel cell and an information device capable of minimizing a change in structure to a standard set of output/input terminals used in the fuel cell or the portable information device.

In an exemplary embodiment of the present invention, a fuel cell is provided including a fuel cell stack for generating electricity by an electrochemical reaction of a fuel and an oxidant; a fuel supplier for supplying the fuel to the fuel cell stack; a set of output terminals for outputting electricity generated from the fuel cell stack and for outputting information on a power generation state of the fuel cell; and a power supply information processing unit for applying a voltage level according to the information to any one of the set of output terminals.

In one embodiment, the set of output terminals includes a ground voltage output terminal; a temperature information output terminal; a data output terminal; a clock output terminal; and a power supply voltage output terminal. The power supply information processing unit applies the voltage level to the temperature information output terminal.

In one embodiment, the power supply information processing unit applies the voltage level corresponding to a remaining amount of fuel in the fuel supplier to said any one of the set of output terminals.

In one embodiment, the power supply information processing unit further includes a judging unit for judging the remaining amount of fuel in the fuel supplier.

In one embodiment, the judging unit includes a flux sensor mounted in a fuel tank of the fuel supplier; and an output circuit for generating the voltage level corresponding to a sensing value of the flux sensor.

In one embodiment, the judging unit includes a timer and a counter for measuring and recording an accumulated operation time of the fuel cell stack; and a converting unit for converting the accumulated operation time recorded in the counter into the remaining amount of fuel.

In one embodiment, the judging unit includes a means for measuring a power generation amount of the fuel cell stack; a counter for recording the power generation amount; and a converting unit for converting the accumulated power generation amount recorded in the counter into the remaining amount of fuel.

In one embodiment, the set of the output terminals includes a ground voltage output terminal; a power supply information output terminal; a temperature information output terminal; a data output terminal; a clock output terminal; and a power supply voltage output terminal. The power supply information processing unit applies the voltage level to the power supply information output terminal.

In one embodiment, the power supply information processing unit applies the voltage level corresponding to a remaining amount of fuel in a fuel tank of the fuel supplier to the power supply information output terminal.

In an exemplary embodiment of the present invention, an information device is provided including a set of input terminals for receiving power from a power supply including a fuel cell; a power supply information extractor for extracting information on a power generation state of the power supply according to a voltage level on any one of the set of input terminals; and a power supply controller for operating a power supply management program according to an extraction value of the power supply information extractor.

In one embodiment, the set of input terminals includes a ground voltage input terminal; a temperature information input terminal; a data input terminal; a clock input terminal; and a power supply voltage input terminal. The power supply information extractor checks the voltage level on the temperature information input terminal.

In one embodiment, the power supply information extractor comprises an analog to digital converter for converting the voltage level into a digital value.

In one embodiment, the power supply controller judges one state of the coupling of the fuel cell and the coupling of a battery by comparing the extraction value and a predetermined reference value, and when judging that the fuel cell is coupled, judges a remaining amount of fuel in the fuel cell according to a degree of the extraction value.

In one embodiment, the set of input terminals includes a ground voltage input terminal; a power supply information input terminal; a temperature information input terminal; a data input terminal; a clock input terminal; and a power supply voltage input terminal. The power supply information extractor checks the voltage level carried on the power supply information input terminal.

In one embodiment, the power supply controller judges a remaining amount of fuel in the fuel cell according to a degree of the extraction value.

In an exemplary embodiment of the present invention, a method of providing information on a fuel cell to a portable information device is provided. The fuel cell includes a fuel cell stack, a fuel supplier for supplying fuel to the fuel cell stack, and a set of output terminals. The method includes determining a remaining amount of the fuel in the fuel supplier; and providing a voltage to one of the set of output terminals indicating the determined remaining amount of fuel.

In one embodiment, the set of output terminals includes a temperature information output terminal and the voltage is provided to the temperature information output terminal indicating a coupling with the fuel cell and the determined remaining amount of fuel.

In one embodiment, the set of output terminals includes a power supply information output terminal and the voltage is provided to the power supply information output terminal indicating the determined remaining amount of fuel.

In one embodiment, the set of output terminals includes a temperature information output terminal and a second voltage is provided to the temperature information output terminal indicating a coupling with the fuel cell.

In one embodiment, a method for determining the remaining amount of fuel in the fuel supplier is selected from the group consisting of: (1) sensing the remaining amount of fuel with a flux sensor mounted in a fuel tank of the fuel supplier; (2) measuring an accumulated operation time of the fuel cell stack with a timer; recording the accumulated operation time of the fuel cell stack with a counter; and converting the measured and recorded accumulated operation time into the remaining amount of fuel; and (3) measuring power generation of the fuel cell stack; recording an amount of the power generation in a counter; and converting the recorded amount of the power generation into the remaining amount of fuel.

### BRIEF DESCRIPTION OF THE DRAWINGS

These and/or other embodiments and features of the invention will become apparent and more readily appreciated from the following description of certain exemplary embodiments, taken in conjunction with the accompanying drawings of which:

FIG. 1A. FIG. 1B, and FIG. 1C are configuration views showing coupling methods of a fuel cell and a notebook;

FIG. 2 illustrates a structure of a set of input terminals for a notebook according to a conventional standard;

FIG. 3 is a block diagram showing a structure of a fuel cell according to one embodiment of the present invention;

FIG. 4 is a block diagram showing a structure of an information device according to one embodiment of the present invention; and

FIG. 5 illustrates a structure of a set of input terminals for a notebook according to one embodiment of the present invention.

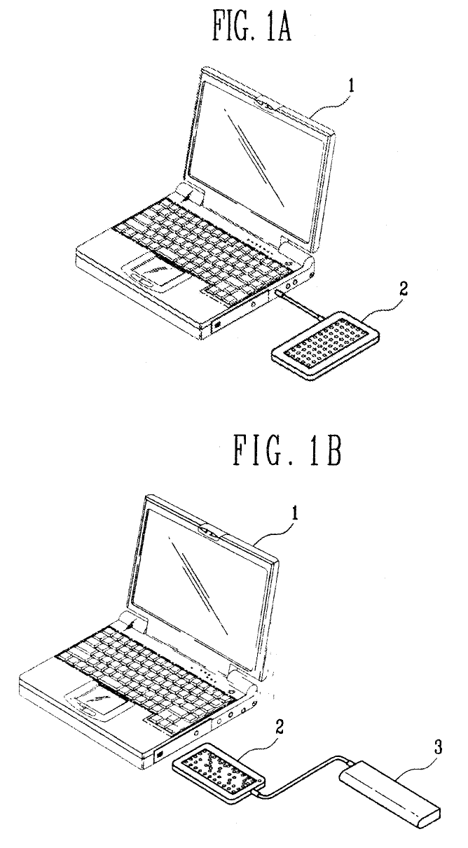

### DETAILED DESCRIPTION

Hereinafter, certain exemplary embodiments according to the present invention will be described with reference to the accompanying drawings. Further, elements that are not essential to the complete understanding of the invention are omitted for clarity. Also, like reference numerals refer to like elements throughout.

Hereinafter, exemplary embodiments of the present invention will be described in a more detailed manner with reference to the accompanying drawings in order for those skilled in the art to easily carry out the exemplary embodiments of the present invention. However, the present invention can be implemented in a variety of forms, but is not limited thereto.

For example, the following exemplary embodiments describe a DMFC fuel cell including a recycler as a fuel cell used for a notebook PC which is a portable information device. However, the following exemplary embodiments can be applied to other portable information devices such as a portable media player (PMP) or a DMB player and can be applied to a micro fuel cell without a recycler or a PEMFC fuel cell. As long as a method of implementing the information device and the fuel cell includes a main idea of exemplary embodiments of the present invention, it is apparent that the methods belong to the scope of the present invention.

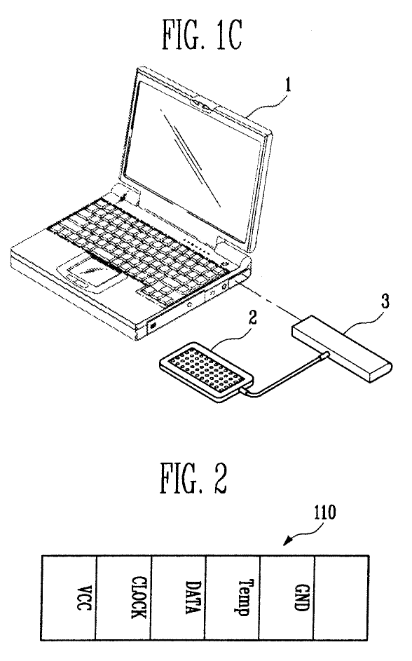

FIG. 2 shows a structure of a set of input terminals 110 widely used as a standard for a battery currently used for a notebook and other portable information devices. The set of input terminals 110 includes a ground voltage input terminal GND, a temperature information input terminal (Temp), a data terminal DATA, a clock terminal CLOCK, and a power supply voltage input terminal VCC.

Driving power is supplied from a battery to a notebook through the ground voltage input terminal GND and the power supply voltage input terminal VCC. A control signal or a state information signal is transferred to the data terminal DATA, and a clock signal is transferred to the clock terminal CLOCK for synchronizing the signal transmission between the battery and the notebook.

A current temperature of a battery is transferred to the temperature information input terminal (Temp). However, there is little need for monitoring temperature of a battery as battery technology has developed. Therefore, according to exemplary embodiment of the present invention, a predetermined level of voltage is applied to the temperature information input terminal (Temp) to allow the notebook to display the coupling of a battery.

In an exemplary embodiment, the temperature information input terminal (Temp) is used not only to display whether a battery is coupled, but also to display the state of a fuel cell or the coupling information of a fuel cell and a battery.

With respect to displaying information on the voltage level, the coupling information of a fuel cell and a battery may be conveyed with discrete values in a particular voltage level region. Further, the information on the remaining amount of fuel in a fuel cell may be conveyed by displaying continuous values in a different voltage level region.

For example, if the temperature information input terminal (Temp) can display up to 5.0V, 4.0V can indicate a state where a battery is coupled, and 3.0V to 0.5V can indicate a state where a fuel cell is coupled. Herein, it can be implemented to indicate a level proportional to the remaining amount of fuel in the fuel tank among levels between 3.0V and 0.5V.

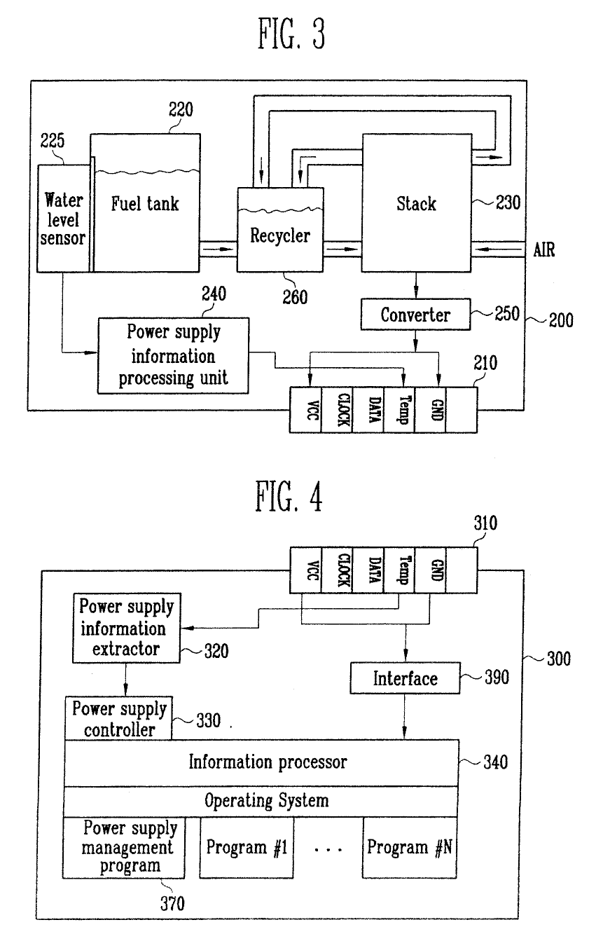

The fuel cell 200 of an exemplary embodiment as shown in FIG. 3 includes a fuel tank 220; a stack for generating power 230; a set of output terminals 210 for outputting power generated from the stack 230 to an external notebook PC; and a power supply information processing unit 240 for applying a voltage level according to the information on the power generation state of the fuel cell to any one of a set of the output terminals 210. The power generated from the stack 230 is stabilized through a converter 250 so that it can be supplied to the outside through the set of output terminals 210. Also, the fuel cell 200 further includes a recycler 260 that dilutes the fuel by mixing fuel with effluents of the stack 230 to supply it to the stack 230.

The stack 230 is a general fuel cell stack and may be implemented by any of PEMFC or DMFC, or the like. According to this embodiment, the stack 230 is a DMFC, which is suitable for mobile devices. According to an implementation, the stack 230 may be a single MEA, but is referred to as a stack for convenience sake.

The fuel cell 200 may further include a fuel supplier comprising a fuel tank 220, a pump, pipes, and the like for supplying fuel and/or oxidant to the fuel cell stack 230. The details are apparent to those skilled in the art and therefore the description thereof will be omitted.

The fuel tank 220 can be a stationary tank to which fluid fuel is injected or a cartridge capable of replacement. Also, it can include a flux sensor 225 for sensing the remaining amount of fuel. The flux sensor 225 can be a water level sensor as shown in the drawings, but to allow for proper sensing with rotation, can be implemented by the flux sensor and a device for estimating accumulated operation time or an accumulated power generation amount.

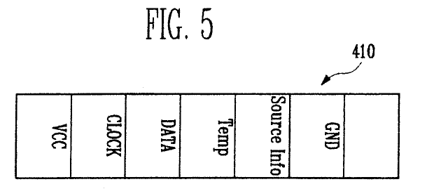

The set of output terminals 210 has a shape and a coupling structure to be engaged with a set of input terminals 310 shown in FIG. 4. In other words, the set of output terminals 210 has a shape that a ground voltage output terminal GND, a temperature information output terminal (Temp), a data terminal DATA, a clock terminal CLOCK, and a power supply voltage output terminal VCC are formed in order.

The power supply information processing unit 240 applies a voltage of a level corresponding to the state of the fuel cell and/or the coupling information of the fuel cell to the temperature information output terminal (Temp) of the set of output terminals 210. For example, the power supply information processing unit 240 can be implemented to indicate a level proportional to the remaining amount of fuel in the fuel tank among levels between 3.0V and 0.5V.

With respect to computing the remaining amount of fuel, there is a method of directly measuring the remaining amount of fuel with the flux sensor 225 mounted in the fuel tank 220. Alternatively, after refilling the fuel tank 220 (in the case of a cartridge mode, an exchange of a cartridge), there is a method of estimating the remaining amount of fuel from an accumulated operation time or an accumulated power generation amount.

With respect to directly measuring the remaining amount of fuel, the power supply information processing unit 240 generates a voltage with a level proportional to a sensing value received from the flux sensor 225 mounted in the fuel tank 220. The power supply information processing unit 240 can be implemented by an output circuit applying a voltage to the temperature information output terminal (Temp). For example, it can be implemented by an analog circuit including an amplifier and a digital circuit using a simple operation processor such as logic gates.

With respect to estimating the remaining amount of fuel, the power supply information processing unit 240 should include an accumulating counter for accumulating the operation time or the power generation amount from the first use time point after the refill of fuel. In the case of using the accumulated operation time, it should include a timer for measuring the operation time and in the case of using the accumulated power generation amount, it should include a means for measuring the power generation amount. As the means of measuring the power generation amount, a measuring instrument of measuring current, voltage, and/or power at any point on an output converter 250 of the fuel cell can be applied. In this case, the power supply information processing unit 240 further includes a converting unit for converting the accumulated power generation amount or the accumulated operation time into the remaining amount of fuel.

In the case of the latter as above, since the power supply information processing unit 240 needs to include the counter and the converting unit, in an exemplary embodiment the power supply information processing unit 240 is implemented by a digital circuit using the operation processor rather than the analog circuit.

The notebook PC 300 of the present exemplary embodiment shown in FIG. 4 includes a set of input terminals 310 coupled to the set of output terminals of the fuel cell to receive power generated from the fuel cell; a power supply information extractor 320 for extracting the state of the fuel cell and/or the coupling information of the fuel cell and the battery at the voltage level applied to any one of the set of input terminals 310; and a power supply controller 330 for operating the corresponding power supply management program according to the extraction value of the power supply information extractor 320.

Also, the notebook PC 300 can further include an interface circuit 390 for converting power supplied to the set of input terminals 310 and for supplying the converted power to the driving power supply of the notebook internal circuit. At this time, the notebook internal circuit includes an information processor 340.

The set of input terminals 310, which is a set of input terminals of a standard used in a general notebook shown in FIG. 2, has a shape that the ground voltage input terminal GND, the temperature information input terminal (Temp), the data terminal DATA, the clock terminal CLOCK, and the power supply voltage input terminal VCC are formed in order. Among other data, the state of the fuel cell or the coupling information of the fuel cell and the battery are input to the temperature information input terminal (Temp).

The power supply information extractor 320 can include an A/D converter for converting an analog level of voltage carried on the temperature information input terminal (Temp) into a digital value.

The power supply controller 330 can be implemented by a software module of a program that is part of the operating system of the portable personal computer. The power supply controller 330 judges the coupling state of the battery and the fuel cell and the remaining amount of fuel in the fuel cell according to the information extracted from the power supply information extractor 320 and performs necessary measures according to the judgment result. If the power supply controller 330 judges that the battery is coupled, the battery power supply management program is operated according to the prior art. If the power supply controller 330 judges that the fuel cell is coupled, the power supply management program for the fuel cell is operated. If the power supply management program for the fuel cell receives indication of a drop in the remaining amount of fuel below a predetermined amount, the power supply management program can alert the user of the portable PC and inform the user of the remaining amount of fuel. Informing users of the remaining amount of fuel can be performed even when the remaining amount of fuel is above the predetermined amount or upon a specific request of the user.

FIG. 5 shows a structure of a set of input terminals 410 of a new standard in an exemplary embodiment of the present invention. The set of input terminals 410 further includes a power supply information input terminal (Source Info) capable of transferring information on the power supply state. The information on the power supply state is transferred to the power supply information input terminal as the voltage level, similar to the case of the first exemplary embodiment. The addition of the power supply information input terminal (Source Info) minimizes the change in a conventional terminal structure of the information device and the fuel cell.

Referring to FIG. 5, the set of input terminals 410 includes the ground voltage input terminal GND, the power supply information input terminal (Source Info), the temperature information input terminal (Temp), the data terminal DATA, the clock terminal CLOCK, and the power supply voltage input terminal VCC.

The driving voltage is supplied from the battery to the notebook through the ground voltage input terminal GND and the power supply voltage input terminal VCC. The control signal or the state information signal is transferred to the data terminal DATA, and the clock for synchronizing the signal transmission between the battery or fuel cell and an information device is transferred to the clock terminal CLOCK.

The current temperature of the external power supply, for example, the fuel cell or the battery, may be transferred to the temperature information input terminal (Temp), but in an exemplary embodiment, coupling information of a fuel cell or a battery is transferred thereto. The power generation state of the fuel cell and/or the coupling information of a fuel cell or a battery are transferred to the power supply information input terminal (Source Info). In the case of using the temperature information input terminal (Temp) for the transfer of the coupling information, only the information on the power generation state of the fuel cell can be transferred to the power supply information input terminal (Source Info).

In the case of displaying both the power generation state of the fuel cell and the coupling information of a fuel cell and a battery with the voltage level of the power supply information input terminal (Source Info), the coupling information of a fuel cell and a battery may be displayed with discrete values in a particular voltage level region. In addition, the information on the remaining amount of fuel in the fuel cell may be displayed with continuous values in a different voltage level region.

For example, if the temperature information input terminal (Temp) can display up to 5.0V, 4.0V can indicate a state where the battery is coupled, and 3.0V to 0.5V can indicate a state where the fuel cell is coupled. Herein, it can be implemented to indicate a level proportional to the remaining amount of fuel in the fuel tank among levels between 3.0V and 0.5V.

The information device implemented according to the present exemplary embodiment is approximately the same as the first exemplary embodiment, except for the set of input terminals 410 further including the power supply information input terminal (Source Info). Also, the fuel cell implemented according to the present embodiment is approximately the same as the first exemplary embodiment, except for the set of power output terminals further including the power supply information output terminal corresponding to the power supply information input terminal (Source Info). Therefore, it can be easily derived from the description of the first exemplary embodiment and the description thereof will be omitted.

With respect to the performance of the fuel cell and/or the information device according to exemplary embodiments of the present invention, the power generation state of the fuel cell supplying power to the information device and/or the coupling information can be transferred to the information device. Providing this information allows a user to take proper measures according to the state of the fuel cell, such as, for example, the exhaustion of fuel.

Also, exemplary embodiments of the present invention provide for a capability of transferring the power generation state of the fuel cell supplying power to the information device and/or the coupling information to the information device and minimizes the change in the structure of the prior art. Exemplary embodiments of the present invention allow for saving costs in implementing the information device for receiving power from the fuel cell.

Although exemplary embodiments of the present invention have been shown and described, it would be appreciated by those skilled in the art that changes might be made in these embodiments without departing from the principles and spirit of the invention, the scope of which is defined in the claims and their equivalents.

What is claimed is:

1. A fuel cell comprising:
a fuel cell stack adapted to generate electricity by an electrochemical reaction of a fuel and an oxidant;
a fuel supplier adapted to supply the fuel to the fuel cell stack;
a set of output terminals adapted to output electricity generated from the fuel cell stack and to output information on a power generation state of the fuel cell; and
a power supply information processing unit adapted to apply a voltage level according to the information to any one of the set of output terminals.

2. The fuel cell as claimed in claim 1, wherein the set of output terminals comprises:
a ground voltage output terminal;
a temperature information output terminal;
a data output terminal;
a clock output terminal; and
a power supply voltage output terminal,
wherein the power supply information processing unit applies the voltage level to the temperature information output terminal.

3. The fuel cell as claimed in claim 1, wherein the power supply information processing unit applies the voltage level corresponding to a remaining amount of fuel in the fuel supplier to said any one of the set of output terminals.

4. The fuel cell as claimed in claim 3, wherein the power supply information processing unit further comprises a judging unit adapted to judge the remaining amount of fuel in the fuel supplier.

5. The fuel cell as claimed in claim 4, wherein the judging unit comprises:
a flux sensor mounted in a fuel tank of the fuel supplier; and
an output circuit adapted to generate the voltage level corresponding to a sensing value of the flux sensor.

6. The fuel cell as claimed in claim 4, wherein the judging unit comprises:
a timer and a counter adapted to measure and to record an accumulated operation time of the fuel cell stack; and
a converting unit adapted to convert the accumulated operation time recorded in the counter into the remaining amount of fuel.

7. The fuel cell as claimed in claim 4, wherein the judging unit comprises:
a means for measuring a power generation amount of the fuel cell stack;
a counter adapted to record the power generation amount; and
a converting unit adapted to convert the accumulated power generation amount recorded in the counter into the remaining amount of fuel.

8. The fuel cell as claimed in claim 1, wherein the set of the output terminals comprises:
a ground voltage output terminal;
a power supply information output terminal;
a temperature information output terminal;
a data output terminal;
a clock output terminal; and
a power supply voltage output terminal,
wherein the power supply information processing unit applies the voltage level to the power supply information output terminal.

9. The fuel cell as claimed in claim 8, wherein the power supply information processing unit applies the voltage level corresponding to a remaining amount of fuel in a fuel tank of the fuel supplier to the power supply information output terminal.

10. An information device comprising:
a set of input terminals adapted to receive power from a power supply including a fuel cell;
a power supply information extractor adapted to extract information on a power generation state of the power supply according to a voltage level on any one of the set of input terminals; and
a power supply controller adapted to operate a power supply management program according to an extraction value of the power supply information extractor.

11. The information device as claimed in claim 10, wherein the set of input terminals comprises:
a ground voltage input terminal;
a temperature information input terminal;
a data input terminal;
a clock input terminal; and
a power supply voltage input terminal,
wherein the power supply information extractor checks the voltage level on the temperature information input terminal.

12. The information device as claimed in claim 10, wherein the power supply information extractor comprises an analog to digital converter for converting the voltage level into a digital value.

13. The information device as claimed in claim 10, wherein the power supply controller judges one state of the coupling of the fuel cell and the coupling of a battery by comparing the extraction value and a predetermined reference value, and when judging that the fuel cell is coupled, judges a remaining amount of fuel in the fuel cell according to a degree of the extraction value.

14. The information device as claimed in claim 10, wherein the set of input terminals comprises:
a ground voltage input terminal;
a power supply information input terminal;
a temperature information input terminal;
a data input terminal;
a clock input terminal; and
a power supply voltage input terminal,
wherein the power supply information extractor checks the voltage level carried on the power supply information input terminal.

15. The information device as claimed in claim 14, wherein the power supply controller judges a remaining amount of fuel in the fuel cell according to a degree of the extraction value.

16. A method of providing information on a fuel cell to a portable information device, the fuel cell including a fuel cell stack, a fuel supplier for supplying fuel to the fuel cell stack, and a set of output terminals, the method comprising:
determining a remaining amount of the fuel in the fuel supplier; and
providing a voltage to one of the set of output terminals indicating the determined remaining amount of fuel.

17. The method of claim 16, wherein the set of output terminals includes a temperature information output terminal and the voltage is provided to the temperature information output terminal indicating a coupling with the fuel cell and the determined remaining amount of fuel.

18. The method of claim 16, wherein the set of output terminals includes a power supply information output terminal and the voltage is provided to the power supply information output terminal indicating the determined remaining amount of fuel.

19. The method of claim 18, wherein the set of output terminals includes a temperature information output terminal and a second voltage is provided to the temperature information output terminal indicating a coupling with the fuel cell.

20. The method of claim 16, wherein a method for determining the remaining amount of fuel in the fuel supplier is selected from the group consisting of:
sensing the remaining amount of fuel with a flux sensor mounted in a fuel tank of the fuel supplier;
measuring an accumulated operation time of the fuel cell stack with a timer; recording the accumulated operation time of the fuel cell stack with a counter; and converting the measured and recorded accumulated operation time into the remaining amount of fuel; and
measuring power generation of the fuel cell stack; recording an amount of the power generation in a counter; and converting the recorded amount of the power generation into the remaining amount of fuel.
